(19) United States
(12) Patent Application Publication
(10) Pub. No.: US 2007/0217659 A1
(43) Pub. Date: Sep. 20, 2007

(54) SYSTEM AND METHOD FOR PERSONAL IDENTIFICATIOIN USING BIOMETRICS DATA, AND COMPUTER-READABLE RECORDING MEDIUM IN WHICH PERSONAL IDENTIFICATION PROGRAM IS STORED

(75) Inventor: Kazuhiro Harada, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/494,490

(22) Filed: Jul. 28, 2006

(30) Foreign Application Priority Data
Mar. 15, 2006 (JP) 2006-071595

(51) Int. Cl. G06K 9/00

(52) U.S. Cl. 382/115

(57) ABSTRACT

A personal identification system using biometrics data including a biometrics data inputting section, a characteristic data obtaining section for obtaining characteristic data of the collation object person, a biometrics data retaining section for retaining registration biometrics data of each registered object person, which data is previously registered and correlated with one of collation groups according to registration characteristic data, and a biometrics data collating section for collating the collation biometrics data with the registration biometrics data, wherein the biometrics data collating section extracts a particular group from the plural collation groups based on the characteristic data of the collation object person, and collates the collation biometrics data with registration biometrics data of the particular group. Consequently, the collation biometrics data can be collated with registration biometrics data of a number of registered object persons in a short time without requiring primary verification using ID and others.

### BACKGROUND OF THE INVENTION

1. Field of the Invention

The present invention relates to a technique for personal identification using biometrics data such as fingerprints, palm prints, finger shapes, palm shapes, voice, retinas, irides, face images, dynamic signatures, blood vessel patterns, or keystrokes.

2. Description of the Related Art

In recent years, collation when entering and exiting a condominium at the entrance and when making a transaction at an automated teller machine is widely adopting personal identification using biometrics data, peculiar to each individual person.

Such personal identification using biometrics data is considered to be more reliable than conventional collation requiring password input. The biometrics data peculiar to each individual person is exemplified by fingerprints, palm prints, finger shapes, palm shapes, voice, retinas, irides, face images, dynamic signatures, blood vessel patterns, or keystrokes.

In a conventional personal identification system using biometrics data, an ID (identity; identification) allocated to each collation object person (each person who enters and exits) is obtained from an ID card or the like, extracts registration biometrics data previously correlated with the obtained ID (primary collation), and the collation object person is verified by collating biometrics data of the person which data is obtained by a biometrics data inputting section (e.g., a fingerprint sensor) with the extracted registration biometrics data. Such personal identification is known as “1:1 verification”.

The method disclosed in the below patent reference 1 is known as personal identification using “1:1 verification”.

As an example, verification of a collation object person is carried out by comparing and collating biometrics data of the collation object person with registration biometrics data to calculate a coincidence rate. If the coincidence rate is a predetermined value or larger, the collation object person is judged to be the same as the registered object person; and conversely a coincidence rate smaller than the predetermined rate judges that the collation object person is not the registered object person.

As described above, a conventional personal identification system using biometrics data carries out, after the primary verification to obtain the ID of a collation object person, “1:1 verification” as secondary verification in which registration biometrics data corresponding to the obtained ID is extracted from registration biometrics data of all the registered object persons, and is collated with the biometrics data of the collation object person, so that time required for personal identification is reduced.

[Patent Reference 1] Japanese Patent Application Laid-Open (KOKAI) No. HEI 05-233896

Since “1:1 verification” requires extraction of registration biometrics data concerning a registered object person from registration biometrics data concerning a number of registered object persons, primary verification to obtain an ID is necessary. For this reason, if a collation object person losses the ID card or forgets the ID number, registration biometrics data corresponding to the ID of the person cannot be extracted and secondary verification cannot be therefore accomplished.

Further, the conventional system requires a complex task of issuing an ID card or the like to each collation object person.

Methods other than the collation method using “N:1 verification” are known to the public. The “N:1 verification” sequentially extracts registration biometrics data concerning a registered object person from registration biometrics data concerning the entire registered object persons one by one and collates each extracted registration biometrics data piece with the biometrics data of the collation object person, so that a number (N, natural number) of biometrics data pieces are collated with the biometrics data of the collation object person.

Accompanying drawing FIG. 12 is a diagram showing a retrieval manner performed in a conventional personal identification system using biometrics data.

Such “N:1 verification” requires no primary collation different from the above “1:1 verification”, and is therefore highly convenient.

However, if the system has a large number of registration biometrics data pieces, “N:1 verification” may require a longer time for verification. In particular, if the registration biometrics data coinciding with the biometrics data of a collation object person is arranged close to the end of the entire registration biometrics data, the collation requires a much longer time.

Alternatively, one solution to reduce time required for collation may be considered to be an improvement in the collation speed in the system, which is realized by preparing equipment capable of high-speed processing or by forming a system configuration with high-speed performance, which results in a system complex in configuration and also high in cost.

As another problem, since an entering/exiting system installed at the entrance of a condominium, for example, arranges the equipment at a fixed position, it is sometimes difficult for a collation object person who is a child or in a wheelchair to operate the equipment.

### SUMMARY OF THE INVENTION

With the foregoing problems in view, the object of the present invention is to collate biometrics data of a collation object person with registration biometrics data concerning a number of registered object persons without requiring primary verification using ID or the like in a shorter time and to provide a personal identification system that is easy to operate.

To attain the above object, as a first generic feature, there is provided a personal identification system using biometrics data, comprising: a biometrics data inputting section for inputting collation biometrics data of a collation object person; a characteristic data obtaining section for obtaining characteristic data of the collation object person; a biometrics data retaining section for retaining registration biometrics data of each registered object person, which registration biometrics data is previously registered and which is correlated with one of a plurality of collation groups in accordance with registration characteristic data of each registered object person; and a biometrics data collating section for collating the collation biometrics data of the collation object person inputted by the biometrics data inputting section with the registration biometrics data previously registered in the biometrics data retaining section, wherein the biometrics data collating section extracts a particular group from the plural collation groups based on the characteristic data of the collation object person, and collates the collation biometrics data with registration biometrics data correlated with the particular group.

As a preferable feature, if the second registration biometrics data correlated with the particular group does not correspond to the collation biometrics data, the biometrics data collating section may collate the collation biometrics data of the collation object person with registration biometrics data which is previously registered and which is correlated with another collation group associated with registration characteristic data close to that associated with the particular group.

As another preferable feature, the plural collation groups may be determined in terms of numeric largeness of the first registration characteristic data; and the biometrics data collating section may sequentially select collation groups other than the particular group in the order of being closer in the numeric largeness of the first registration characteristic data to the particular group as another collation group from the plural group.

As an additional preferable feature, the characteristic data of the collation object person and the registration characteristic data may concern the height of the collation object person and the height of each registered object person, respectively.

As a further preferable feature, the biometrics data inputting section may include an input sensor for inputting the collation biometrics data of the collation object person and a driving section for moving the input sensor based on the characteristic data obtained by the characteristic data obtaining section.

As a still further preferable feature, the input sensor may include a rotation axis across the horizontal direction thereof, so that the input sensor rotates around the rotation axis; and the driving section may include an angle adjusting section for determining an angle of the input sensor based on the characteristic data obtained by the characteristic data obtaining section.

As a second generic feature, there is provided a method for personal identification using biometrics data, comprising the steps of: (a) inputting collation biometrics data of a collation object person; (b) obtaining characteristic data of the collation object person; (c) retaining registration biometrics data of each registered object person, which registration biometrics data is previously registered and which is correlated with one of a plurality of collation groups in accordance with registration characteristic data of each registered object person; and (d) collating the collation biometrics data of the collation object person inputted in the (a) of inputting biometrics data with the registration biometrics data previously registered in the step (c) of retaining registration biometrics data, wherein the step (d) of collating includes sub-steps of extracting a particular group from the plural collation groups based on the characteristic data of the collation object person obtained in the step (b) and collating the collation biometrics data with registration biometrics data correlated with the particular group.

As a preferable feature, if the second registration biometrics data correlated with the particular group does not correspond to the collation biometrics data, the step (d) of collating further may include the sub-steps of collating the collation biometrics data of the collation object person with registration biometrics data which is previously registered and which is correlated with another collation group associated with registration characteristic data close to that associated with the particular group.

As another preferable feature, the plural collation groups may be determined in terms of numeric largeness of the first registration characteristic data; and the step (d) of collating may be performed by sequentially selecting collation groups other than the particular group in the order of being closer in the numeric largeness of the first registration characteristic data to the particular group as the another collation group from the plural group.

As an additional preferable feature, the characteristic data of the collation object person and the registration characteristic data may concern the height of the collation object person and the height of each registered object person, respectively.

As a third generic feature, there is provided a computer-readable recording medium in which a program for personal identification using biometrics data is stored, the program instructing a computer to execute the steps of: (a) inputting collation biometrics data of a collation object person; (b) obtaining characteristic data of the collation object person; (c) retaining registration biometrics data of each registered object person, which registration biometrics data is previously registered and which is correlated with one of a plurality of collation groups in accordance with registration characteristic data of each registered object person; and (d) collating the collation biometrics data of the collation object person inputted in the (a) of inputting biometrics data with the registration biometrics data previously registered in the step (c) of retaining registration biometrics data, wherein the step (d) of collating includes sub-steps of extracting a particular group from the plural collation groups based on the characteristic data of the collation object person obtained in step (b) and collating the collation biometrics data with registration biometrics data correlated with the particular group.

As a preferable feature, if the second registration biometrics data correlated with the particular group does not correspond to the collation biometrics data, the step (d) of collating further may include the sub-steps of collating the collation biometrics data of the collation object person with biometrics data which is previously registered and which is correlated with another collation group associated with registration characteristic data close to that associated with the particular group.

As another preferable feature, the plural collation groups may be determined in terms of numeric largeness of the first registration characteristic data; and the step (d) of collating may be performed by sequentially selecting collation groups other than the particular group in the order of being closer in the numeric largeness of the first registration characteristic data to the particular group as the another collation group from the plural group.

As an additional preferable feature, the characteristic data of the collation object person and the registration characteristic data may concern the height of the collation object person and the height of each registered object person, respectively.

The present invention retains registration biometrics data of each registered object person by correlating one for each of the collation groups that have been determined in terms of registration characteristic data; extracts a particular collation group based on the characteristic data of the collation object person; and collates the collation biometrics data of the collation object person with registration biometrics data correlated with the extracted particular collation group. In this manner, it is possible to reduce the amount of registered biometrics data that is to be used for collation with the collation biometrics data of the collation object person and to reduce the time required for verification. Since the collation is performed by “N:1 verification” and primary verification using ID or the like is therefore not required, the present invention is highly convenient.

If registration biometrics data correlated with the particular group extracted does not correspond to collation biometrics data of the collation object person, collation with the collation biometrics data is performed on registration biometrics data correlated with another collation group associated with registration characteristic data close to that associated with the particular group. With this feature, even when the proper collation group in which the registration biometrics data of the collation object person is previously registered is not selected as the particular group because of an error of the characteristic data of the collation object person, the proper collation group is selected as such another collation group so that it is possible to surely carry out collation of the collation biometrics data with registration biometrics data. At that time, since collation is performed on registration biometrics data in a collation group close to the particular group, the number of times of extraction of another collation group can be small.

As a consequence, the present invention can collate the collation biometrics data with the entire registration biometrics data in a short time.

Since the characteristic data of the collation object person and the registration characteristic data may concern the height of the collation object person and the height of each registered object person, respectively, data sufficient to select the particular collation group from the plural collation groups can be easily obtained simply by taking a photograph of the appearance of each collation object person, time required for specifying the particular group can be reduced.

Since the biometrics data inputting section is movable in accordance with the characteristic data of the collation object person, various collation object persons, differing in body shape and in orientation, can input biometrics data into the biometrics data inputting section, which therefore provides high operability.

For example, even if a collation object person is a child or a person in a wheelchair, the biometrics data inputting section of the present invention makes it possible to input collation biometrics data from a low position.

Other objects and further features of the present invention will be apparent from the following detailed description when read in conjunction with the accompanying drawings.

### BRIEF DESCRIPTION OF THE DRAWINGS

FIG. 1 is a block diagram schematically showing a personal identification system according to a first embodiment of the present invention;

FIG. 2(a) is a perspective view illustrating a terminal unit used for the personal identification system of FIG. 1;

FIG. 2(b) is a perspective view illustrating a biometrics data inputting section of the personal identification system of FIG. 1;

FIG. 3 is a block diagram schematically showing a configuration of the biometrics data inputting section of the personal identification system of FIG. 1;

FIG. 4 is a block diagram schematically showing a configuration of the characteristic data obtaining section of the personal identification system of FIG. 1;

FIG. 5 is a diagram illustrating a manner of obtaining characteristic data of the personal identification system of FIG. 1;

FIG. 6(a) is a diagram illustrating an example of an image of a collation object person used for the personal identification system of FIG. 1;

FIG. 6(b) is a diagram showing a template for an image of a collation object person of FIG. 6(a);

FIG. 6(c) is a diagram showing a state in which the image of a collation object person is superimposed on the template of FIG. 6(b);

FIG. 7 is a diagram showing an example of a number of collation groups provided in a biometrics data retaining section of the personal identification system of FIG. 1;

FIG. 8 is a diagram showing an example of biometrics data registered in a biometrics data retaining section of the personal identification system of FIG. 1;

FIG. 9 is a diagram showing a method for extracting a collation group by a biometrics data collation section of the personal identification system of FIG. 1;

FIG. 10 is a flow diagram showing a succession of procedural steps carried out in the personal identification system of FIG. 1;

FIG. 11 is a diagram showing a modification of the personal identification system of FIG. 1; and

FIG. 12 is a diagram showing a retrieval method in “N:1 verification” in conventional personal identification.

### DESCRIPTION OF THE PREFERRED EMBODIMENTS

A preferred embodiment of the present invention will now be described with reference to the accompanying drawings.

### (1) First Embodiment

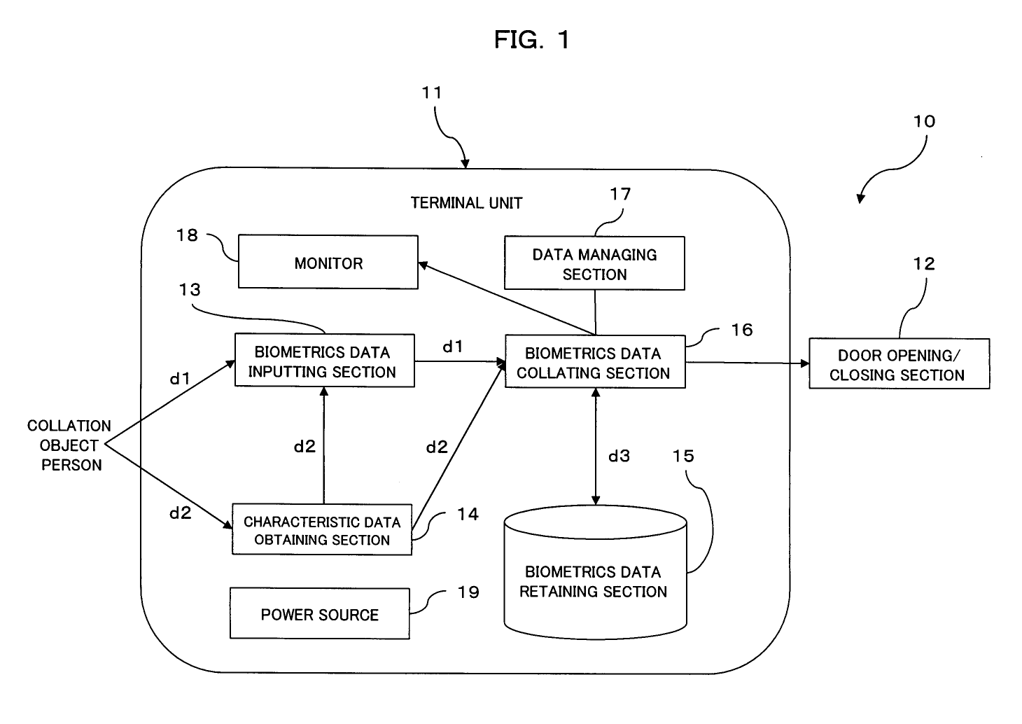

The personal identification system of the first embodiment of the present invention will now be described with reference to FIGS. 1-8, exemplifying an access control system used in an entrance of a condominium.

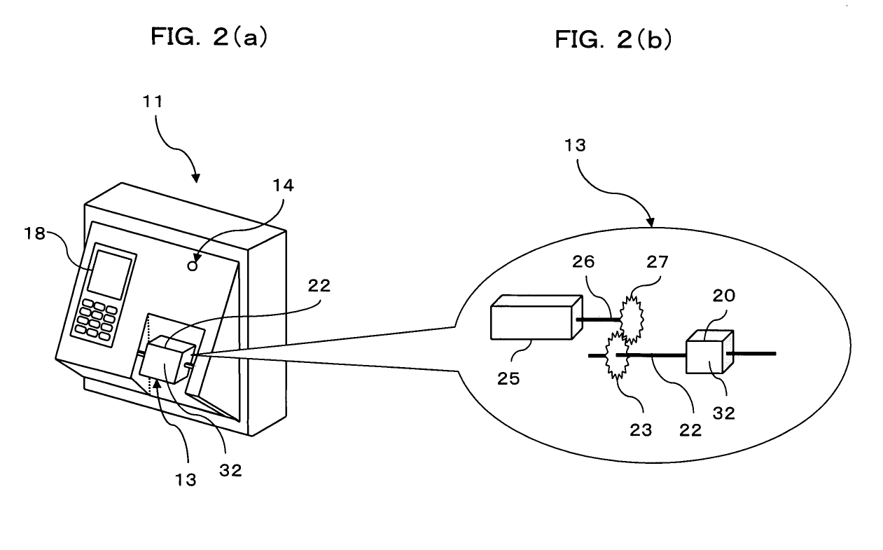

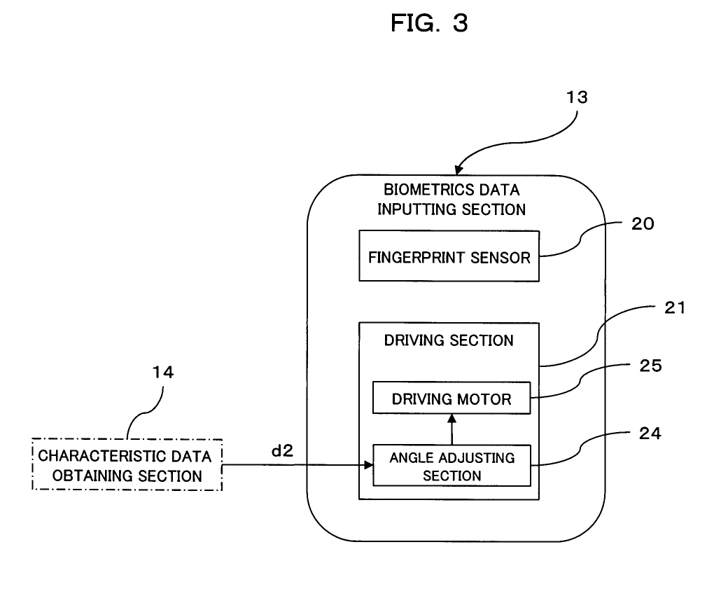

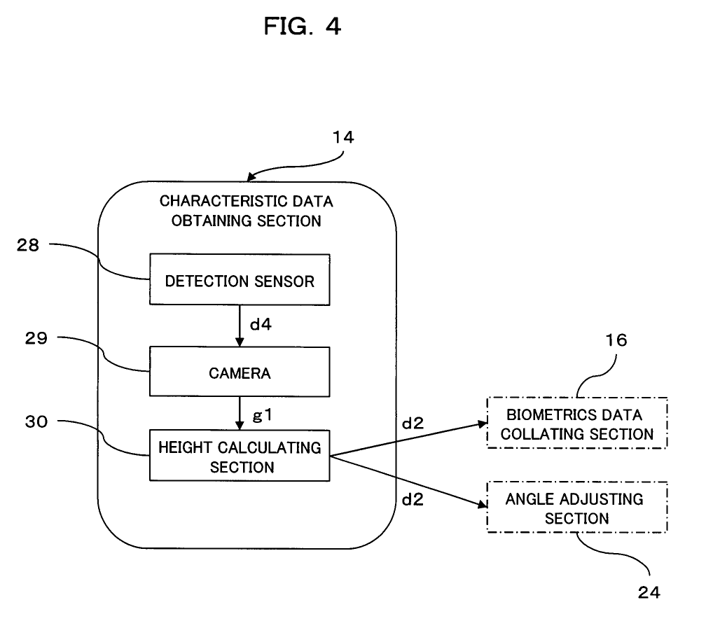

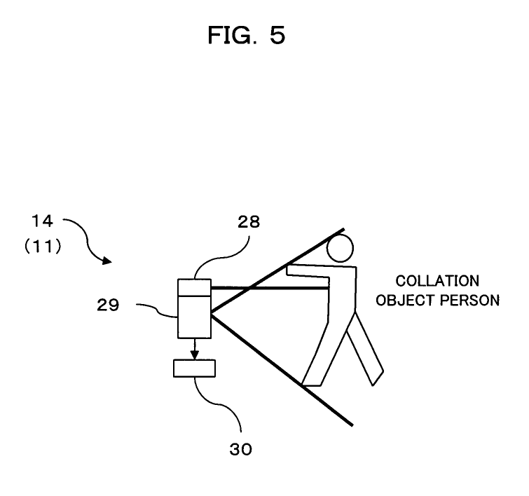

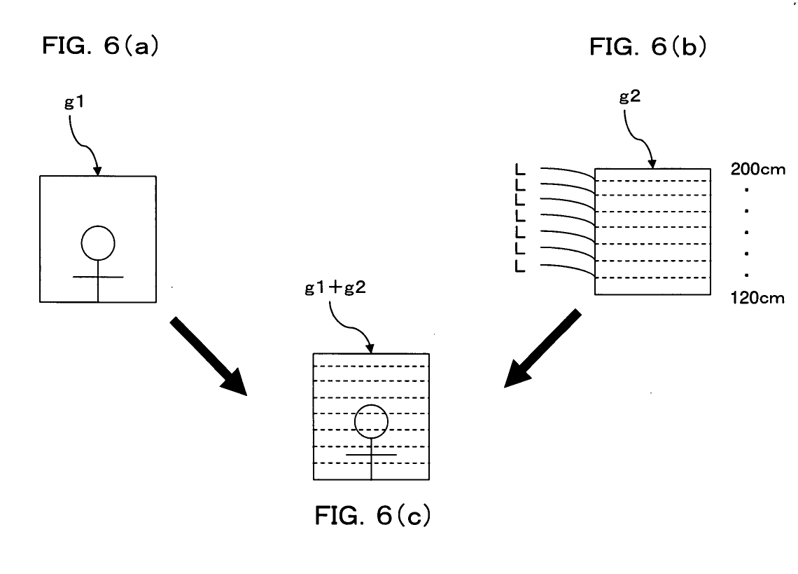

FIG. 1 is a block diagram schematically showing a personal identification system according to the first embodiment; FIG. 2(a) is a perspective view illustrating a terminal unit; FIG. 2(b) is a perspective view illustrating a configuration of a biometrics data inputting section; FIG. 3 is a block diagram schematically showing a biometrics data inputting section; FIG. 4 is a block diagram schematically showing a characteristic data obtaining section; FIG. 5 is a diagram illustrating a manner of obtaining characteristic data; FIG. 6(a) is a diagram illustrating an example of an image of a collation object person; FIG. 6(b) is a diagram showing a template for an image of a collation object person; and FIG. 6(c) is a diagram showing a state in which the image of a collation object person is superimposed on the template.

The personal identification system 10 using biometric data according to the first embodiment includes, as shown in FIG. 1, a terminal unit 11 installed on a wall and others so that a collation object person can operate it, and also a door opening/closing section 12 for opening or closing the door based on information output from the terminal unit 11.

As shown in FIGS. 1 and 2, the terminal unit 11 includes a biometrics data inputting section 13, a characteristic data obtaining section 14, a biometrics data retaining section 15, a biometrics data collating section 16, a data managing section 17, a monitor 18 and a power source 19.

In the present embodiment, description is made assuming that height and a fingerprint are used as characteristic data d2 and biometrics data d1, respectively.

The biometrics data inputting section 13 collects biometrics data d1 of each collation object person, and includes a fingerprint sensor 20 and a sensor driving section 21 as shown in FIG. 3.

The fingerprint sensor 20 collects a fingerprint image (biometrics data d1) of each collation object person, and has an outer surface which functions as a sensor surface 32 so that the collation object person can input the fingerprint even when the orientation of the sensor surface 32 moves upwards or downwards.

In addition, the fingerprint sensor 20 has a rotation axis 22 across the horizontal direction thereof, so that the fingerprint sensor 20 rotates (moves) around the rotation axis 22. The rotation of the rotation axis 22 changes the angle of the sensor surface 32. As shown in FIG. 2(b), a slave gear 23 is fixed to the rotation axis 22.

The sensor driving section (driving section) 21 turns the fingerprint sensor 20 (the sensor surface 32) based on characteristic data obtained by characteristic data obtaining section 14 that is to be detailed below, and includes an angle adjusting section 24 for adjusting the angle of the fingerprint sensor 20 based on characteristic data obtained by the characteristic data obtaining section 14 and a driving motor 25 which operates based on angle information determined by the angle adjusting section 24, as shown in FIG. 3. The driving motor is exemplified by a stepping motor.

As shown in FIG. 2(b), a spindle 26 which is rotated by driving force produced by the driving motor 25 is attached to the driving motor 25, and further a driving gear 27 is fixed to the spindle 26, which engages with the above-described slave gear 23. With this configuration, the rotation of the spindle 26 rotates the rotation axis 22.

The characteristic data obtaining section 14 obtains characteristic data d2 of a collation object person, and includes a detection sensor 28, a camera 29, and a height calculating section 30, as shown in FIGS. 4 and 5.

The detection sensor 28 detects the presence of a collation object person in proximity to the terminal unit 11 and takes the form of an infrared-ray emitting sensor, for example. The detection sensor 28 outputs collation object person detection data d4 to the camera 29 in the event of detection of the presence of a collation object person.

The detection sensor 28 should by no means be limited to an infrared-ray emitting sensor, and various modifications and alternations can be suggested.

The camera 29 obtains an image g1 of a collation object person by taking a photograph of the collation object person based on collation object person detection data d4 from the detection sensor 28, and is exemplified by a camera which obtains digital images. Upon receipt of collation object person detection data d4, the camera 29 takes the photograph of the collation object person to obtain a collation object person image g1, which is then output to the height calculating section 30.

The height calculating section 30 calculates the height of a collation object person from the collation object person image g1 obtained by the camera 29.

The height calculating section 30 originally retains a template image g2 for height measurement shown in FIG. 6(b) in a memory (not shown), and superimposes the collation object person image g1 (see FIG. 6(a)) output from the camera 29 on the template image g2, as shown in FIG. 6(c).

As shown in FIG. 6(b), the template image g2 has scale levels L vertically arranged at fixed intervals. When the template image g2 is superimposed on a collation object person image g1, as shown in FIG. 6(c), the height calculating section 30 judges whether or not the collation object person image g1 is present at a region between two adjacent scale levels L and Land determines that the height data d2 of the collation object person is in the region immediately below the lowest region at which the collation object person image is not present. In the present invention, the scale levels L are attached to from 120 to 200 cm at intervals of 10 cm and characteristic data (height data) d2 of a collation object person is calculated in units of 10 cm, for example “in the range of from 140 to 150 cm.”

The height data d2 calculated by the height calculating section 30 is output to the angle adjusting section 24 and the biometrics data collating section 16, as shown in FIG. 4.

On the basis of the height data d2 of the collation object person output from the height calculating section 30, the angle adjusting section 24 determines the angle of the sensor surface 32 suitable for the collation object person. The angle of the sensor surface 32 is previously set in accordance with height data d2 of collation object persons, and is determined for each unit of 10 cm correspondingly to the height data d2 of a collation object person.

The biometrics data retaining section 15 retains registration biometrics data d3 of each registered object person previously registered and takes the form of a database (DB) realized by a storage device such as a HDD (Hard Disk Drive) or a memory.

In the biometrics data retaining section 15, registration biometrics data d3 of each registered object person is previously correlated with one collation group from a number of collation groups which one collation group is determined in accordance with the height of the registered object person. The registration biometrics data d3 is exemplified by a fingerprint image.

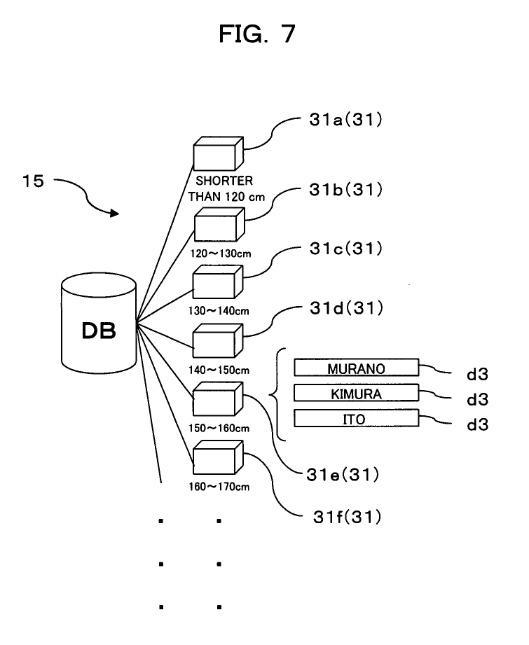

FIG. 7 is diagram showing an example of the collation groups formed in the biometrics data retaining section 15. In the illustrated example, the biometrics data retaining section 15 retains the collation groups 31a, 31b, 31c, 31d, 31e, 31f . . . , provided one for each of the predetermined height ranges.

In the below description, reference numbers 31a, 31b, 31c, 31d, 31e, 31f . . . are used to specify individual collation groups and an arbitrary collation group is represented by reference number 31.

Registration biometrics data d3 of each registered object person is retained in one of the collation groups 31a, 31b, 31c, 31d, 31e, 31f . . . which corresponds to the height of the registered object person (the step of registering biometrics data).

The collation groups 31 of the present embodiment correspond one to each 10-cm interval determined by two adjacent scale levels L and L. Specifically, registration biometrics data of registered object persons whose height is shorter than 120 cm is correlated with (classified into) collation group 31a; registration biometrics data of registered object persons having the height of 120-130 cm are correlated with collation group 31b; registration biometrics data of registered object persons having the height of 130-140 cm are correlated with collation group 31c; registration biometrics data of registered object persons having the height of 140-150 cm are correlated with collation group 31d; registration biometrics data of registered object persons having the height of 150-160 cm are correlated with collation group 31e; and registration biometrics data of registered object persons having the height of 160-170 cm are correlated with collation group 31f.

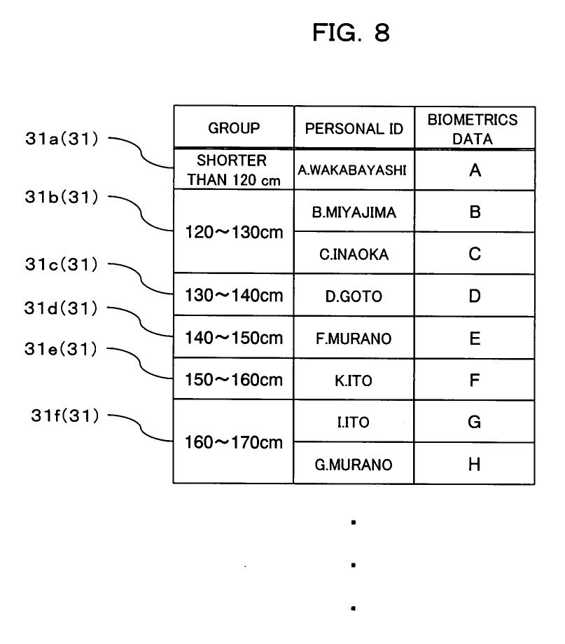

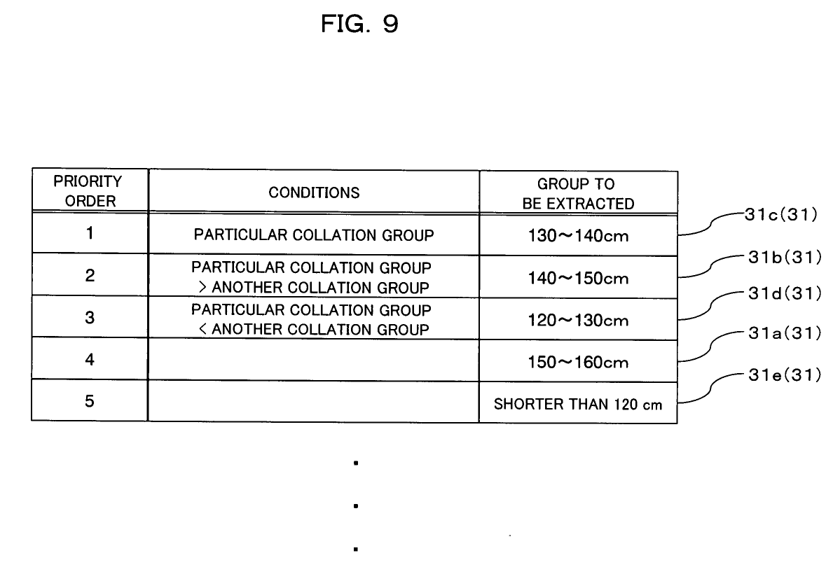

For example as shown in FIG. 8, biometrics data A of “A. WAKABAYASHI” whose height is shorter than 120 cm is classified into collation group 31a and registered in the biometrics data retaining section 15; and biometrics data B of “B. MIYAJIMA” whose height is in the range of 120-130 cm is classified into collation group 31b and registered in the biometrics data retaining section 15. In the same manner, biometrics data C of “C. INAOKA” whose height is in the range of 120-130 cm is classified into collation group 31b and registered in the biometrics data retaining section 15; biometrics data D of “D. GOTO” whose height is in the range of 130-140 cm is classified into collation group 31c and registered in the biometrics data retaining section 15; biometrics data E of “F. MURANO” whose height is in the range of 140-150 cm is classified into collation group 31d and registered in the biometrics data retaining section 15; biometrics data F of “K. ITO” whose height is in the range of 150-160 cm is classified into collation group 31e and registered in the biometrics data retaining section 15; biometrics data D of “I. ITO” whose height is in the range of 160-170 cm is classified into collation group 31f and registered in the biometrics data retaining section 15; and biometrics data H of “G. MURANO” whose height is in the range of 160-170 cm is classified into collation group 31f and registered in the biometrics data retaining section 15.

The biometrics data collating section 16 collates biometrics data d1 collected by the biometrics data inputting section 13 with registration data d3 previously registered and retained in the biometrics data retaining section 15. As shown in FIG. 1, the biometrics data collating section 16 extracts a particular collation group from the collation groups retained in the biometrics data retaining section 15 based on the height data d2 of a collation object person obtained by the characteristic data obtaining section 14, and collates the biometrics data of the collation object person with registration biometrics data d3 correlated with the particular collation group 31 that has been extracted. The result of collating is output to door opening/closing section 12 and the monitor 18.

Specifically, the biometrics data collating section 16 extracts one from the collation groups 31a, 31b, 31c, 31d, 31e, 31f . . . which one corresponds to the height data of the collation object person output from the characteristic data obtaining section 14.

Then the biometrics data collating section 16 collates the biometrics data d1 of the collation object person with the registration biometrics data d3 of every registered object person correlated with the particular collation group 31.

If the biometrics data collating section 16 finds no registration biometrics data d3 corresponding to the biometrics data d1 of the collation object person in the particular collation group 31 extracted based on the height data d2 of the same collation object person, the biometrics data collating section 16 preferentially extracts a collation group 31 having a value (of characteristic data) to specify the group closest to the lower limit (the shorter limit of the height) of the particular collation group, and collates the biometrics data d1 of the collation object person with the registration biometrics data d3 of every registered object person correlated with the newly extracted collation group 31. In the same manner, the biometrics data collating section 16 sequentially selects collation groups 31 being closer in height value to the particular collation group one by one and collates the biometrics data d1 of the collation object person with the registration biometrics data d3 of every registered object person correlated with each of collation groups sequentially selected.

For example, when the height calculating section 30 calculates the height of a collation object person to be in the range of 130-140 cm, the biometrics data collating section 16 extracts the collation group 31c as the particular collation group to begin with.

Then, if registration biometrics data d3 corresponding to the biometrics data d1 of the collation object person is not found in the particular collation group 31c, the biometrics data collating section 16 extracts the collation group 31b immediately below the particular collation group 31c and collates the biometrics data d1 of the collation object person with the registration biometrics data d3 of every registered object person which data d3 is correlated to the collation group 31b.

Then, if the registered biometrics data d3 in the extracted collation group 31b does not correspond to the biometrics data d1 of the collation object person, the biometrics data collating section 16 extracts the collation group 31d immediately above the particular collation group 31c. The biometrics data collating section 16 successively extracts collation groups 31a, 31e, . . . , and carries out the above collation on each extracted group.

In this case, the biometrics data collating section 16 preferably extracts collation groups alternately from the lower collation groups 31 and upper collation groups 31 in relation to the particular collation group 31 that has been first extracted.

The above procedure is performed until registration biometrics data d3 corresponding to the biometrics data d1 of the collation object person is found, and terminates when registration biometrics data d3 corresponding to the biometrics data d1 is found or if collation on the entire registration biometrics data d3 detects no registration biometrics data d3 corresponding to the biometrics data d1.

If collation results in finding registration biometrics data d3 corresponding to the biometrics data d1, the biometrics data collating section 16 sends the door opening/closing section 12 a signal to allow entrance of the collation object person, and the door opening/closing section 12 opens the door (not shown).

The data managing section 17 manages entrance and exit history, which history is correlated with information about the registration biometrics data d3 that has been judged to correspond to the biometrics data d1 of the collation object person as a result of collation by the biometrics data collating section 16, the information being exemplified by name and time and date of entrance.

The monitor 18 displays the result of collation made by the biometrics data collating section 16 and additionally displays instructions to an operator (a collation object person).

The power source 19 supplies each element of the terminal unit 11 with electricity.

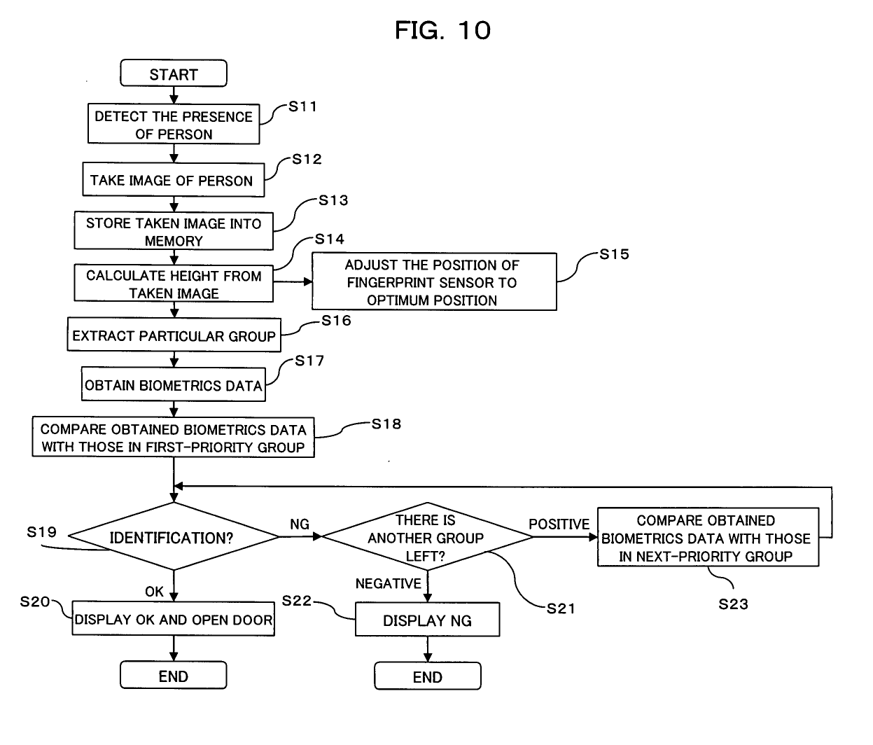

Hereinafter, description will now be made in relation to a succession of procedural steps performed in the personal identification system using biometrics data of the first embodiment with reference to FIG. 10 (steps S11-S22).

First of all, when a collation object person approaches the terminal unit 11, the detection sensor 28 detects the presence of the collation object person (step S11) and sends collation object person detection data d4 to the camera 29.

Upon receipt of the collation object person detection data d4, the camera 29 takes the image of the collation object person to obtain the collation object person image g1 (step S12; a step of obtaining characteristic data), which is stored in the memory (step S13). The camera 29 outputs the collation object person image g1 to the height calculating section 30.

The height calculating section 30 superimposes the collation object person image g1 on the template image g2 stored in the height calculating section 30, and calculates height data d2 of the collation object person by judging the presence or the absence of the collation object person image g1 at each region defined by two neighboring scale levels L and L (step S14). The height calculating section 30 sends the calculated height data d2 to the angle adjusting section 24 and the biometrics data collating section 16.

The angle adjusting section 24 determines the optimum position of the sensor surface 32 responsive to input of the height data d2, and adjusts the angle of the sensor surface 32 by driving the driving motor 25 to arrange the sensor surface 32 to the optimum position (step S15; the step of driving).

The biometrics data collating section 16 extracts the particular collation group 31 from collation groups 31 based on the height data d2 input from the characteristic data obtaining section 14 (step S16; the step of extracting a collation group).

Further, the biometrics data collating section 16 obtains biometrics data d1 through the biometrics data inputting section 13 (step S17; the step of inputting biometrics data) and collates the biometrics data d1 of the collation object person with all the registration biometrics data d3 correlated with the extracted particular collation group 31 with the first priority (step S18; the step of collating biometrics data) for personal identification (step S19).

Here, if the biometrics data d1 of the collation object person coincides with the registration biometrics data d3 (OK route of step S19), the biometrics data collating section 16 outputs the result of collating to the monitor 18 and the door opening/closing section 18. Responsively, the monitor 18 displays OK and the door opening/closing section 12 opens the door (step S20), and the succession of procedural steps terminates.

Conversely, if the biometrics data d1 does not correspond to the registration biometrics data d3 (NEGATIVE route of step S19), the biometrics data collating section 16 judges the presence or the absence of a collation group 31 with which the biometrics data d1 has not been collated by judging whether or not there is another collation group that has not been extracted (step S21).

If the result of the judgment is negative (NEGATIVE route of step S21), the biometrics data collating section 16 outputs the result of collating to the monitor 18, on which “NG” is displayed (step S22) and the procedure terminates without opening the door.

On the other hand, if the result of judgment is positive (POSITIVE route of step S21), the biometrics data collating section 16 extracts a collation group 31 closest to the particular collation group 31 and collates the entire registration biometrics data d3 in the extracted another collation group 31 with the biometrics data d1 of the collation object person for comparison with a collation group with the next priority (step S23).

In this case, if a collation group 31 which is below the particular collation group 31 and which is the closest to the particular collation group 31 has not been extracted, the biometrics data collating section 16 successively extracts close collation groups one by one for collation and returns to step S19.

As described above, the personal identification system 10 using biometrics data of the present embodiment stores registration biometrics data d3 of registered object persons by correlating one for each of the collation groups 31 that have been determined in terms of characteristic data d2; extracts a particular collation group 31 based on the characteristic data d2 of the collation object person; and collates the biometrics data d1 with registration biometrics data d3 correlated with the extracted particular collation group. In this manner, it is possible to reduce the amount of registered biometrics data d3 that is to be used for collation with the biometrics data d1 of the collation object person and to reduce the time required for verification. Since the collation is performed by “N:1 verification” and primary verification using ID or the like is therefore not required, the personal identification has a high level of convenience.

Further, if registration biometrics data d3 corresponding to the biometrics data d1 of the collation object person is not found in the extracted particular collation group 31, collation with the biometrics data d1 of the collation object person is performed on registration biometrics data d3 correlated with another collation group whose characteristic data d2 is close to that of the extracted particular collation group. In this manner, even if the characteristic data d2 of a collation object person has an error because of the collation object person wearing high-heeled shoes, for example, and therefore the collation group 31 correlated with the registration biometrics data d3 of the collation object person is selected as the particular collation group 31, it is possible to surely and rapidly extract the proper collation group 31 correlated with the registration biometrics data d3 of the collation object person from the remaining collation group 31. As a result, the collation group 31 related with the registration biometrics data d3 can be extracted by a small number of extraction times.

Further, it is possible to completely perform collation on all the registration biometrics data and also to reduce time required for collation.

The use of height as characteristic data d2 makes it possible to obtain enough characteristic data d2 to extract the particular collation group 31 from a number of collation groups 31 simply by taking an appearance image of a collation object person with the camera 29, and time required for extracting the particular collation group can be reduced.

If no registration biometrics data d3 corresponding to the biometrics data d1 of the collation object person is found in the particular collation group 31 extracted, the biometrics data collating section 16 preferentially extracts collation group 31 which is below the particular collation group 31 and which is closest to the particular collation group 31. In the event of personal identification for a collation object person who is a child, who grows up rapidly, or a person who wears high-heeled shoes, even if the biometrics data collating section 16 extracts a collation group 31 which is correlated with a higher height than that of the true particular collation group 31 in which registration biometrics data d3 of the collation object person is previously registered as a particular collation group 31 for the collation object person, it is possible to extract the true particular collation group 31 at an early stage and to carry out accurate personal identification in a shorter time.

Prior to input of the biometrics data d1 by a collation object person, the biometrics data inputting section 13 (the sensor surface 32) is moved based on characteristic data d2, so that various collation object persons, respectively different in body shape and in orientation, can input biometrics data d1 into the biometrics data inputting section 13.

In particular, even if a collation object person is a child or a person in a wheelchair, the driving section 21 adjusts the angle of the sensor surface 32 so that the sensor surface 32 is directed downwards because of the use of height as characteristic data d2. As a result, it is possible to improve operability and the collation object person short in height can input the biometrics data d1 into the biometrics data inputting section 13 from the low position with ease.

(B) Others:

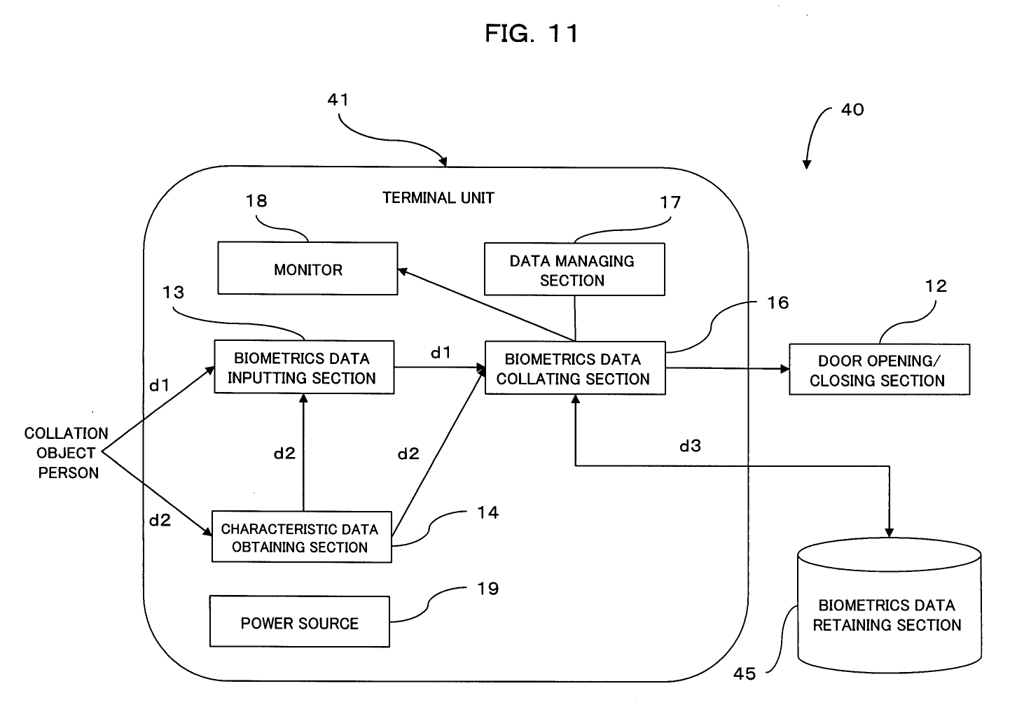

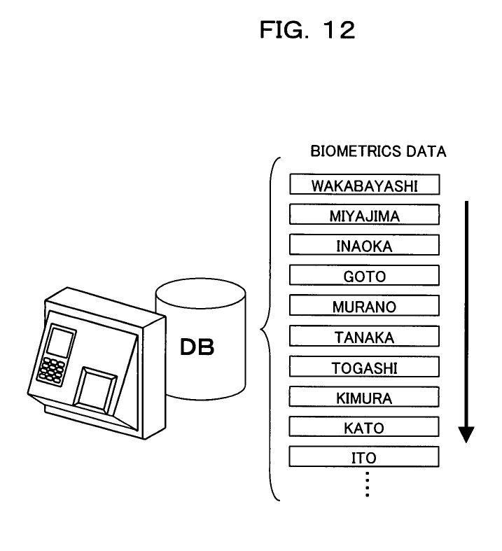

The present invention should by no means be limited to the foregoing embodiment, various changes and modifications can be suggested without departing from the gist of the present invention. FIG. 11 is a block diagram schematically showing a modification to the terminal unit 11 of the first embodiment.

For example, the biometrics data retaining section 15 is installed in the terminal unit 11 in the first embodiment, but should by no means be limited to this. As shown in FIG. 11, the biometrics data retaining section 45 may be installed outside the terminal unit 41.

In the first embodiment, the fingerprint sensor 20 rotates around the rotation axis 22 but should by no means be limited to this. The fingerprint sensor 20 may shift (move) in the horizontal or vertical direction.

Further, the first embodiment uses fingerprints as biometrics data, to which the present invention should by no means be limited. The biometrics data may be palm prints, finger shape, palm shape, voice, retinas, irides, face images, dynamic signatures, blood vessel patterns, keystrokes or the like.

The first embodiment is described, exemplifying an entrance/exit management system for the entrance of a condominium, to which the present invention should by no means be limited. The present invention can be used for other purposes.

The first embodiment uses heights of collation object persons as characteristic data, but characteristic data should by no means be limited to height. The characteristic data may be body weights of collation object persons, and in this case, the characteristic data obtaining section 14 can take the form of a body-weight measurement scale or a body-weight sensor to measure the weights of collation object persons.

The first embodiment collates biometrics data d1 collected by the fingerprint sensor 20 with the registration biometrics data d3, but the present invention should by no means be limited to this. Particular data (e.g., characteristic points) extracted from a fingerprint of each registration object person may be registered as registration biometrics data d3, a particular data extracting section (not shown) may extract the particular data (e.g., characteristic points) based on a fingerprint image d1 collected by the fingerprint sensor 20, and the biometrics data collating section 16 may collate the particular data with registration biometrics data d3.

The functions of biometrics data collating section 16, the data managing section 17, the door opening/closing section 12, the angle adjusting section 24 and the height calculating section 30 in the above-described personal identification system 10 using biometrics data may be realized by a computer (including a CPU, an information processor, or various terminals) executing a predetermined program (a program for personal identification using biometrics data).

The program is provided in the form of being recorded in a computer-readable recording medium exemplified by a flexible disk, a CD (CD-ROM, CD-R, CD-RW), a DVD (DVD-ROM, DVD-RAM, DVD-R, DVD-RW, DVD+R, DVD+RW). In this case, a computer reads the program for personal identification using biometrics data from the recording medium, and sends and stores in an internal or external storage unit for use. Alternatively, the program may be recorded in a storage unit (a recording medium) such as a magnetic disk, an optical disk and a magnet-optical disk, and may be provided to a computer from the storage unit through a communication line.

Here, a computer is a concept of a combination of hardware and an OS (Operating System) and means hardware that operates under control of the OS. Additionally, if an application program operates hardware independently of an OS, the hardware corresponds to the computer. Hardware includes at least a microprocessor such as a CPU and means to read a computer program recorded in a recording medium.

The application program serving as the above personal identification program using biometrics data is in the form of a program code for realizing the functions of biometrics data collating section 16, the data managing section 17, the door opening/closing section 12, the angle adjusting section 24 and the height calculating section 30 in the above-described personal identification system 10, which program code is installed in a computer. Alternatively, the functions may be partially realized by the OS, not by the application program.

The recording medium used in the first embodiment may be various computer-readable recording media such as an IC card, a ROM cartridge, a magnetic tape, a punch card, an internal storage unit (RAM or ROM) for a computer, an external storage unit, or a printing manner on which codes, such as bar codes, are printed, in addition to a flexible disk, a CD, a DVD, a magnetic disk, an optical disk and a magnet-optical disk.

What is claimed is:

1. A personal identification system using biometrics data, comprising:
a biometrics data inputting section for inputting collation biometrics data of a collation object person;
a characteristic data obtaining section for obtaining characteristic data of said collation object person;
a biometrics data retaining section for retaining registration biometrics data of each registered object person, which registration biometrics data is previously registered and which is correlated with one of a plurality of collation groups in accordance with registration characteristic data of said each registered object person; and
a biometrics data collating section for collating the collation biometrics data of said collation object person inputted by said biometrics data inputting section with the registration biometrics data previously registered in said biometrics data retaining section, wherein
said biometrics data collating section extracts a particular group from the plural collation groups based on the characteristic data of said collation object person, and collates the collation biometrics data with registration biometrics data correlated with the particular group.

2. A personal identification system according to claim 1, wherein if the second registration biometrics data correlated with the particular group does not correspond to the collation biometrics data, said biometrics data collating section collates the collation biometrics data of said collation object person with registration biometrics data which is previously registered and which is correlated with another collation group associated with registration characteristic data close to that associated with the particular group.

3. A personal identification system according to claim 2, wherein:
the plural collation groups are determined in terms of numeric largeness of the first registration characteristic data; and
said biometrics data collating section sequentially selects collation groups other than the particular group in the order of being closer in the numeric largeness of the first registration characteristic data to the particular group as another collation group from the plural group.

4. A personal identification system according to claim 1, wherein the characteristic data of said collation object person and the registration characteristic data concern the height of said collation object person and the height of said each registered object person, respectively.

5. A personal identification system according to claim 2, wherein the characteristic data of said collation object person and the registration characteristic data concern the height of said collation object person and the height of said each the registered object person, respectively.

6. A personal identification system according to claim 3, wherein the characteristic data of said collation object person and the registration characteristic data concern the height of said collation object person and the height of said each the registered object person, respectively.

7. A personal identification system according to claim 1, wherein said biometrics data inputting section includes an input sensor for inputting the collation biometrics data of said collation object person and a driving section for moving said input sensor based on the characteristic data obtained by said characteristic data obtaining section.

8. A personal identification system according to claim 7, wherein:
said input sensor includes a rotation axis across the horizontal direction thereof, so that said input sensor rotates around the rotation axis; and
said driving section includes an angle adjusting section for determining an angle of said input sensor based on the characteristic data obtained by said characteristic data obtaining section.

9. A method for personal identification using biometrics data, comprising the steps of:
(a) inputting collation biometrics data of a collation object person;
(b) obtaining characteristic data of said collation object person;
(c) retaining registration biometrics data of each registered object person, which registration biometrics data is previously registered and which is correlated with one of a plurality of collation groups in accordance with registration characteristic data of said each registered object person; and
(d) collating the collation biometrics data of said collation object person inputted in said (a) of inputting biometrics data with the registration biometrics data previously registered in said step (c) of retaining registration biometrics data, wherein
said step (d) of collating includes sub-steps of extracting a particular group from the plural collation groups based on the characteristic data of said collation object person obtained in said step (b) and collating the collation biometrics data with registration biometrics data correlated with the particular group.

10. A method for personal identification according to claim 9, wherein if the second registration biometrics data correlated with the particular group does not correspond to the collation biometrics data, said step (d) of collating further includes the sub-steps of collating the collation biometrics data of said collation object person with registration biometrics data which is previously registered and which is correlated with another collation group associated with registration characteristic data close to that associated with the particular group.

11. A method for personal identification according to claim 10, wherein:
the plural collation groups are determined in terms of numeric largeness of the first registration characteristic data; and
said step (d) of collating is performed by sequentially selecting collation groups other than the particular group in the order of being closer in the numeric largeness of the first registration characteristic data to the particular group as said another collation group from the plural group.

12. A method for personal identification according to claim 9, wherein the characteristic data of said collation object person and the registration characteristic data concern the height of said collation object person and the height of said each registered object person, respectively.

13. A method for personal identification according to claim 10, wherein the characteristic data of said collation object person and the registration characteristic data concern the height of said collation object person and the height of said each registered object person, respectively.

14. A method for personal identification according to claim 11, wherein the characteristic data of said collation object person and the registration characteristic data concern the height of said collation object person and the height of said each registered object person, respectively.

15. A computer-readable recording medium in which a program for personal identification using biometrics data is stored, said program instructing a computer to execute the steps of:
(a) inputting collation biometrics data of a collation object person;
(b) obtaining characteristic data of said collation object person;
(c) retaining registration biometrics data of each registered object person, which registration biometrics data is previously registered and which is correlated with one of a plurality of collation groups in accordance with registration characteristic data of said each registered object person; and
(d) collating the collation biometrics data of said collation object person inputted in said (a) of inputting biometrics data with the registration biometrics data previously registered in said step (c) of retaining registration biometrics data, wherein
said step (d) of collating includes sub-steps of extracting a particular group from the plural collation groups based on the characteristic data of said collation object person obtained in step (b) and collating the collation biometrics data with registration biometrics data correlated with the particular group.

16. A computer-readable recording medium in which a program for personal identification using biometrics data is stored according to claim 15, wherein if the second registration biometrics data correlated with the particular group does not correspond to the collation biometrics data, said step (d) of collating further includes the sub-steps of collating the collation biometrics data of said collation object person with registration biometrics data which is previously registered and which is correlated with another collation group associated with registration characteristic data close to that associated with the particular group.

17. A computer-readable recording medium in which a program for personal identification using biometrics data is stored according to claim 16, wherein:
the plural collation groups are determined in terms of numeric largeness of the first registration characteristic data; and
said step (d) of collating is performed by sequentially selecting collation groups other than the particular group in the order of being closer in the numeric largeness of the first registration characteristic data to the particular group as said another collation group from the plural group.

18. A computer-readable recording medium in which a program for personal identification using biometrics data is stored according to claim 15, wherein the characteristic data of said collation object person and the registration characteristic data concern the height of said collation object person and the height of said each registered object person, respectively.

19. A computer-readable recording medium in which a program for personal identification using biometrics data is stored according to claim 16, wherein the characteristic data of said collation object person and the registration characteristic data concern the height of said collation object person and the height of said each registered object person, respectively.

20. A computer-readable recording medium in which a program for personal identification using biometrics data is stored according to claim 17, wherein the characteristic data of said collation object person and the registration characteristic data concern the height of said collation object person and the height of said each registered object person, respectively.
